(19) United States
(12) Patent Application Publication
(10) Pub. No.: US 2026/0267917 A1
(43) Pub. Date: Sep. 10, 2026

(54) METHOD AND SYSTEM FOR TRACEABLE AND TRUSTWORTHY FINGERPRINTING OF VENDOR RAW DATA IN CHROMATOGRAPHY-MASS SPECTROMETRY

(71) Applicant: National Institute of Metrology, China, Beijing (CN)

(72) Inventors: Xingchuang Xiong, Beijing (CN); Yinchu Wang, Beijing (CN); Wei Zhang, Beijing (CN); Zhen Liu, Beijing (CN); Wenkui He, Beijing (CN)

(21) Appl. No.: 19/662,269

(22) Filed: Apr. 29, 2026

(30) Foreign Application Priority Data
Sep. 25, 2025 (CN) 202511381139.X

(51) Int. Cl. G06F 16/901

(52) U.S. Cl. CPC G06F 16/9014

(57) ABSTRACT

The present application provides a method and a system for traceable and reliable fingerprinting of vendor raw data in chromatography-mass spectrometry. The method includes: selecting vendor raw data in chromatography-mass spectrometry based on a vendor rule set to obtain key fragments; performing segmented hash calculation on the key fragments to obtain a structured fingerprint; digitally signing the structured fingerprint to obtain a trusted timestamp and constructing an evidence block; embedding the evidence block and corresponding mapping information to obtain an embedding result; associating the vendor raw data in chromatography-mass spectrometry, conversion activities, responsible entities, and the evidence block based on the embedding result to obtain a provenance record; and recalculating the vendor raw data in chromatography-mass spectrometry using the evidence block based on the provenance record, and comparing the structured fingerprint, digital signature, and the trusted timestamp to obtain a trusted fingerprint provenance result.

### CROSS-REFERENCE TO RELATED APPLICATIONS

This application claims priority to Chinese Patent Application No. CN202511381139.X, filed on September 25, 2025, which is hereby incorporated by reference in its entirety.

### TECHNICAL FIELD

The present application relates to the technical field of analytical chemistry informatics and data governance, and in particular, to a method and a system for traceable and reliable fingerprinting of vendor raw data in chromatography-mass spectrometry.

### BACKGROUND

In chromatography-mass spectrometry experiments, including gas chromatography-mass spectrometry (GC-MS), liquid chromatography-mass spectrometry (LC-MS), data-dependent acquisition/data-independent acquisition (DDA/DIA), and multiple reaction monitoring/parallel reaction monitoring (MRM/PRM), vendor raw data are commonly stored in proprietary RAW formats, such as Thermo *.RAW, Agilent *.d, and Bruker .d/.tdf. Downstream scenarios, including scientific reproducibility, regulatory compliance modules, and standard reference data (SRD) database entry, require highly reliable original evidence. Conventional technologies generally adopt file-level hash calculations, such as MD5 or SHA, which cannot localize specific vendor key domains that may have been tampered with. Moreover, after conversion from RAW to open formats, such as mzML, original reliable evidence often cannot be transmitted together with the conversion product, making it difficult for downstream processes to verify data source and integrity. In addition, metadata of RAW files may be legitimately or illegitimately modified during secondary processing, and traditional methods lack fine-grained evidence for key fragments, including header domains, indices, and scan directories, as well as continuous traceability across formats.

In mass spectrometry analysis, authenticity and traceability of RAW files are critical for the reliability of scientific data. Data provenance records information regarding entities, activities, and associated participants, which is significant for error localization, quality assurance, and result credibility. In mass spectrometry analysis, authenticity and traceability of RAW files are critical for the reliability of scientific data. Data provenance records information regarding entities, activities, and associated participants, which is significant for error localization, quality assurance, and result credibility. Conventional approaches typically calculate checksums, such as MD5 or SHA-2 hashes, for entire RAW files to verify whether files are damaged during transmission or storage. File-level hashing can only confirm whether the overall file has changed and cannot provide fine-grained localization of tampered content or identify newly introduced fabricated data during processing. Therefore, relying solely on file-level MD5 or similar measures cannot satisfy the high-reliability traceability requirements of scientific research.

Scientific data sharing and publication often require submission of original mass spectrometry data (RAW). However, RAW formats differ among vendors, such as .RAW from Thermo Fisher Scientific Inc., .d folder or MHDAC from Agilent Technologies, Inc., .baf/.yep from Bruker Corporation, .wiff from SCIEX, .raw directory from Waters, Shimadzu and other Japanese vendors, and domestic mass spectrometer formats. These heterogeneous proprietary formats present challenges for unified traceability verification. Furthermore, if experimental data are attempted to be falsified by providing only the converted mzML without the original RAW, or by supplying RAW files that have been tampered with while retaining format integrity, current technologies lack effective means to detect such modifications.

### SUMMARY

Aiming at the foregoing defects in the prior art, the present application provides a method and a system for traceable and reliable fingerprinting of vendor raw data in chromatography-mass spectrometry, which resolves the problem in the prior art of difficulty in performing end-to-end trustworthy verification and anomaly alerting across formats.

To achieve the above objective, the present application adopts the following technical solution. A method for traceable and reliable fingerprinting of vendor raw data in chromatography-mass spectrometry includes:

S1: selecting vendor raw data in chromatography-mass spectrometry based on a vendor rule set to obtain key fragments;

S2: performing segmented hash calculation on the key fragments to obtain a structured fingerprint;

S3: digitally signing the structured fingerprint to obtain a trusted timestamp and constructing an evidence block;

S4: embedding the evidence block and corresponding mapping information during conversion of the vendor raw data in chromatography-mass spectrometry into a target format data file to obtain an embedding result;

S5: associating the vendor raw data in chromatography-mass spectrometry, conversion activities, responsible entities, and the evidence block based on the embedding result to obtain a provenance record; and

S6: recalculating the vendor raw data in chromatography-mass spectrometry using the evidence block based on the provenance record, and comparing the structured fingerprint, digital signature, and the trusted timestamp to obtain a trusted fingerprint provenance result, thereby completing traceable and reliable fingerprinting of vendor raw data in chromatography-mass spectrometry.

Further, the S2 includes:

locating bit-level content of key fields when reading the vendor raw data in chromatography-mass spectrometry, and calculating a hash value through segmented hash calculation, thereby obtaining a structured fingerprint.

Further, the S4 includes:

embedding the evidence block and corresponding mapping information during conversion of the vendor raw data in chromatography-mass spectrometry into the target format data file, recording the structured fingerprint, digital signature, and the trusted timestamp by adding custom fields, thereby obtaining the embedding result.

Further, the S5 includes:

constructing entities by using the embedding result, and associating the vendor raw data in chromatography-mass spectrometry, conversion activities, responsible entities, and the evidence block through an entity-activity-agent model, thereby obtaining the provenance record.

Further, the S6 includes:

recalculating the vendor raw data in chromatography-mass spectrometry by using the evidence block based on the provenance record to obtain key hash values;

comparing the structured fingerprint, the digital signature, and the trusted timestamp respectively by using the key hash values, verifying whether the digital signature is valid, checking whether a timestamp chain sequence is reasonable, and triggering an anomaly alert when any verification step is mismatched, thereby obtaining the trusted fingerprint provenance result, and completing traceable and reliable fingerprinting of the vendor raw data in chromatography-mass spectrometry.

The present application provides a system for traceable and reliable fingerprinting of vendor raw data in chromatography-mass spectrometry, which includes:

a selector module, configured to select vendor raw data in chromatography-mass spectrometry based on a vendor rule set to obtain key fragments;

a fingerprint generation module, configured to perform segmented hash calculation on the key fragments to obtain a structured fingerprint;

a signature and timestamp module, configured to digitally sign the structured fingerprint to obtain a trusted timestamp and construct an evidence block;

a binding and output module, configured to embed the evidence block and corresponding mapping information during conversion of the vendor raw data in chromatography-mass spectrometry into a target format data file to obtain an embedding result;

a provenance record module, configured to associate the vendor raw data in chromatography-mass spectrometry, conversion activities, responsible entities, and the evidence block based on the embedding result to obtain a provenance record; and

a verification and alert module, configured to recalculate the vendor raw data in chromatography-mass spectrometry using the evidence block based on the provenance record, compare the structured fingerprint, digital signature, and the trusted timestamp to obtain a trusted fingerprint provenance result, thereby completing traceable and reliable fingerprinting of vendor raw data in chromatography-mass spectrometry.

The present application provides a device for traceable and reliable fingerprinting of vendor raw data in chromatography-mass spectrometry, which includes a processor, where the processor is configured to execute the method for traceable and reliable fingerprinting of vendor raw data in chromatography-mass spectrometry according to any one of the above aspects.

The present application provides a computer-readable storage medium, where the storage medium stores computer instructions, and when a computer reads the computer instructions stored in the storage medium, the computer executes the method for traceable and reliable fingerprinting of vendor raw data in chromatography-mass spectrometry according to any one of the above aspects.

The present application has the beneficial effects as follows: according to the method for traceable and reliable fingerprinting of vendor raw data in chromatography-mass spectrometry provided in the present application, key fragments, including key header fields and indices of RAW, are selected based on a vendor rule set, segmented hash values are calculated and organized as a structured fingerprint, and the structured fingerprint is digitally signed and timestamped; during conversion of RAW into a target format, the evidence block, mapping information from RAW to the target format, and the provenance record are embedded together or attached together; and during a verification stage, the structured fingerprint, the signature, and the timestamp are recalculated and compared, and an anomaly is alerted and a fragment is localized when an abnormality occurs. Through this method, the fine-grained and localizable integrity verification of key domains of the vendor can be achieved; the continuous-chain provenance can be achieved during conversion from RAW to the target format; the adaptation of rule sets across vendors and versions is supported; and therefore the method is suitable for database access control, cross-institution exchange, and real-time verification. Under conditions that key domains are reasonably selected and signature/timestamp implementation is correct, a high detection rate for unauthorized modification can be achieved and false positives can be significantly reduced.

### BRIEF DESCRIPTION OF DRAWINGS

This specification will be further described in the manner of exemplary embodiments, and the exemplary embodiments will be described in detail with reference to the accompanying drawings. The embodiments are not limiting. In these embodiments, identical reference numerals denote identical structures.

FIG. 1 is a schematic diagram of modules of a system for traceable and reliable fingerprinting of vendor raw data in chromatography-mass spectrometry according to some embodiments of the present specification;

FIG. 2 is an exemplary flowchart of a method for traceable and reliable fingerprinting of vendor raw data in chromatography-mass spectrometry according to some embodiments of the present specification;

FIG. 3 is an exemplary schematic diagram of an MS2 spectrum of xylazine according to some embodiments of the present specification;

FIG. 4 is an exemplary schematic diagram of basic spectrum information according to some embodiments of the present specification;

FIG. 5 is an exemplary schematic diagram of instrument status information according to some embodiments of the present specification; and

FIG. 6 is an exemplary schematic diagram of spectrum data according to some embodiments of the present specification.

### DESCRIPTION OF EMBODIMENTS

The following description of the specific embodiments of the present application is provided to facilitate the understanding of the present application by those skilled in the art. However, it should be understood that the present application is not limited to the scope of the specific embodiments, and for those of ordinary skill in the art, various changes that are made without departing from the spirit and scope of the present application as defined and determined by the appended claims are apparent, and all applications and creations that are made by using the concept of the present application are within the protective scope.

### Embodiment 1

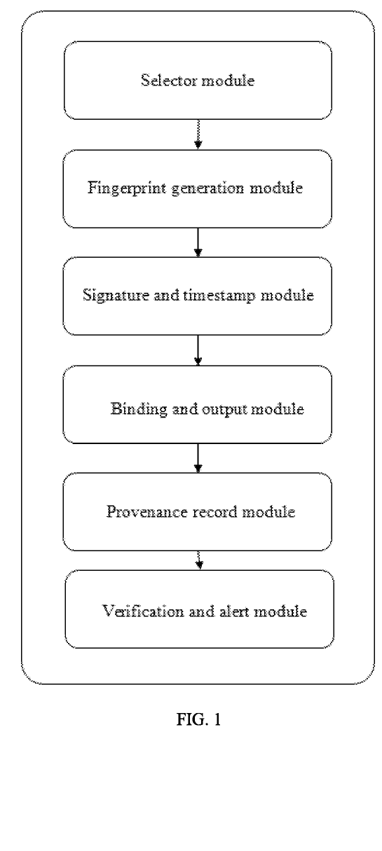

FIG. 1 is a schematic diagram of modules of a system for traceable and reliable fingerprinting of vendor raw data in chromatography-mass spectrometry according to some embodiments of the present specification.

In some embodiments, the system for traceable and reliable fingerprinting of vendor raw data in chromatography-mass spectrometry may include a selector module, a fingerprint generation module, a signature and timestamp module, a binding and output module, a provenance record module, and a verification and alert module.

The selector module is configured to select vendor raw data in chromatography-mass spectrometry based on a vendor rule set to obtain key fragments.

In some embodiments, the selector module may define selection rules for key header fields, indices, and fields that cannot be legitimately modified or are difficult to be legitimately modified according to RAW structures of different vendors.

The selector module supports version management of the vendor rule set to adapt to different vendors and software versions of different vendors.

The fingerprint generation module is configured to perform segmented hash calculation on the key fragments to obtain a structured fingerprint.

In some embodiments, the fingerprint generation module may perform accurate bit-level extraction on selected fields, calculate fragment hash values (preferably SHA-256/512), and organize the fragment hash values in a structured manner (such as a Merkle tree or a hierarchical hash list), to obtain RAW-hash; and support incremental calculation and streaming calculation (for large files and online acquisition scenarios).

A Merkle tree is a hash-based data structure, and a core function of the Merkle tree is efficient verification of integrity, consistency, and authenticity of large-scale datasets.

The signature and timestamp module is configured to digitally sign the structured fingerprint to obtain a trusted timestamp and construct an evidence block.

In some embodiments, the signature and timestamp module may digitally sign RAW-hash or a Merkle root by using a private key; perform time anchoring on a hash value or a signature by calling trusted timestamping authority (TSA); and support local hardware security module (HSM)/key management, and certificate revocation checking.

A hardware security module is a physical device (or embedded chip) specially configured to protect, manage, and use cryptographic keys. A core function of the hardware security module is to provide a highly secure cryptographic operation environment at a hardware level, prevent theft or tampering of keys, and ensure security and compliance of sensitive operations, including encryption/decryption and digital signature/verification.

The binding and output module is configured to embed the evidence block and corresponding mapping information during conversion of the vendor raw data in chromatography-mass spectrometry into a target format data file to obtain an embedding result.

In some embodiments, the binding and output module may embed (or provide through an attached sidecar file) the following information in mzML conversion output: rawTrust.hash (structured information including segmented information/tree information); rawTrust.signature (signature and certificate chain); rawTrust.timestamp (TSA token/proof); rawTrust.mapping (reference mapping from RAW fragments to mzML entities/scans for localization and provenance); and PROV-O provenance (prov:Entity/prov:Activity/prov:Agent describing acquisition, conversion, verification steps, and responsible entities).

PROV-O provenance is a standardized semantic web ontology established by the World Wide Web Consortium (W3C), and a core objective of PROV-O provenance is to solve mutual understanding and exchangeability of provenance information among different systems.

The provenance record module is configured to associate the vendor raw data in chromatography-mass spectrometry, conversion activities, responsible entities, and the evidence block based on the embedding result to obtain a provenance record.

The provenance record module outputs entities, activities, agents, and relationships compliant with PROV-O.

The verification and alert module is configured to recalculate the vendor raw data in chromatography-mass spectrometry using the evidence block based on the provenance record, compare the structured fingerprint, digital signature, and the trusted timestamp to obtain a trusted fingerprint provenance result, thereby completing traceable and reliable fingerprinting of vendor raw data in chromatography-mass spectrometry.

In some embodiments, the verification and alert module may, for any given RAW and mzML carrying evidence, recalculate RAW-hash and compare the signature and timestamp; and trigger an anomaly alert (including localization of an inconsistent fragment) when any key-domain hash is inconsistent or a certificate or timestamp is invalid or expired. A logging and auditing interface is provided to facilitate database access review and regulatory sampling inspection.

In some embodiments, the system for traceable and reliable fingerprinting of vendor raw data in chromatography-mass spectrometry may be configured to execute a method for traceable and reliable fingerprinting of vendor raw data in chromatography-mass spectrometry, which includes: S1: selecting vendor raw data in chromatography-mass spectrometry based on a vendor rule set to obtain key fragments; S2: performing segmented hash calculation on the key fragments to obtain a structured fingerprint; S3: digitally signing the structured fingerprint to obtain a trusted timestamp and constructing an evidence block; S4: embedding the evidence block and corresponding mapping information during conversion of the vendor raw data in chromatography-mass spectrometry into a target format data file to obtain an embedding result; S5: associating the vendor raw data in chromatography-mass spectrometry, conversion activities, responsible entities, and the evidence block based on the embedding result to obtain a provenance record; and S6: recalculating the vendor raw data in chromatography-mass spectrometry using the evidence block based on the provenance record, and comparing the structured fingerprint, digital signature, and the trusted timestamp to obtain a trusted fingerprint provenance result, thereby completing traceable and reliable fingerprinting of vendor raw data in chromatography-mass spectrometry.

In some embodiments of this specification, the processor executes the method for traceable and reliable fingerprinting of vendor raw data in chromatography-mass spectrometry by using the system for traceable and reliable fingerprinting of vendor raw data in chromatography-mass spectrometry. Through this method, the fine-grained and localizable integrity verification of key domains of the vendor can be achieved; the continuous-chain provenance can be achieved during conversion from RAW to the target format; the adaptation of rule sets across vendors and versions is supported; and therefore the method is suitable for database access control, cross-institution exchange, and real-time verification. Under conditions that key domains are reasonably selected and signature/timestamp implementation is correct, a high detection rate for unauthorized modification can be achieved and false positives can be significantly reduced.

In some embodiments, for chromatography-mass spectrometry files from different vendors, different rule sets may be defined based on the trusted fingerprint provenance result according to a corresponding format (based on original binary encoding). That is, key and characteristic data blocks are extracted.

In some embodiments, a CA certificate of a signing authority or a signer (digital identity identifier) is generated by a commercially trusted cryptographic hardware device. The identity and authorization information of CA certificate is traceable and verifiable.

In some embodiments, a trusted timestamp server provides trusted time and a digital signature of an authority, ensuring that signed data and signing time are trustworthy and verifiable.

In some embodiments, the method for traceable and reliable fingerprinting of vendor raw data in chromatography-mass spectrometry enables fine-grained localization of data at a selector (defined by a rule set), with localization to data blocks. The data format conversion process is recorded, reproduced, and verified by the provenance record module.

### Embodiment 2

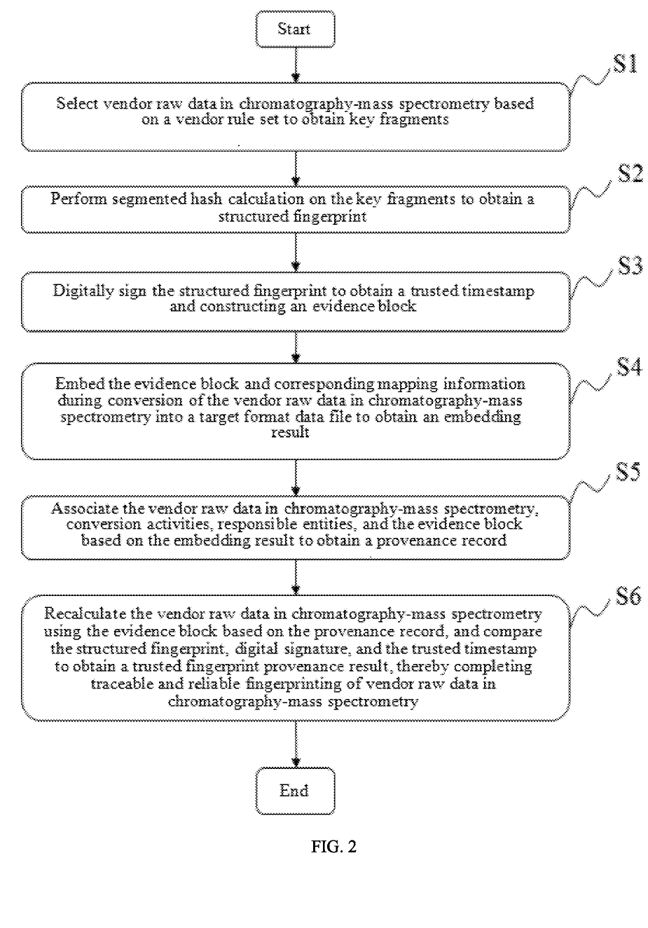

FIG. 2 is an exemplary flowchart of a method for traceable and reliable fingerprinting of vendor raw data in chromatography-mass spectrometry according to some embodiments of the present specification. As shown in FIG. 2, the process includes the following steps. In some embodiments, the process may be executed by a processor.

S1: Vendor raw data in chromatography-mass spectrometry is selected based on a vendor rule set to obtain key fragments.

The vendor rule set is a RAW structure description and fragment selection rule set for a specific vendor, model, or software version, where RAW is a mass spectrometry data format.

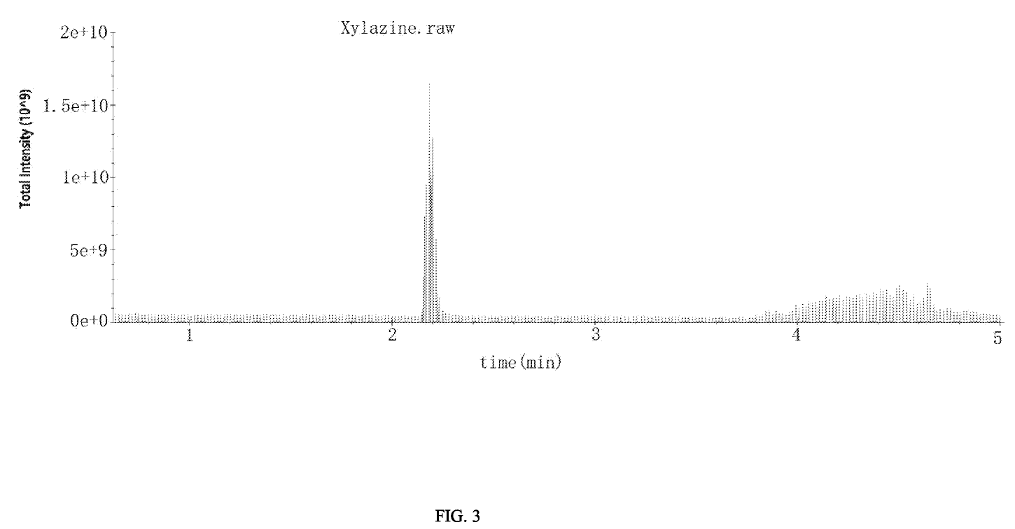

Vendor raw data (RAW) in chromatography-mass spectrometry is a vendor-specific mass spectrometry raw data file or a directory-form data set. As shown in FIG. 3, in doping detection for xylazine, RAW data are used for qualitative analysis through target ions and corresponding second-order mass spectrometry (MS2) spectra.

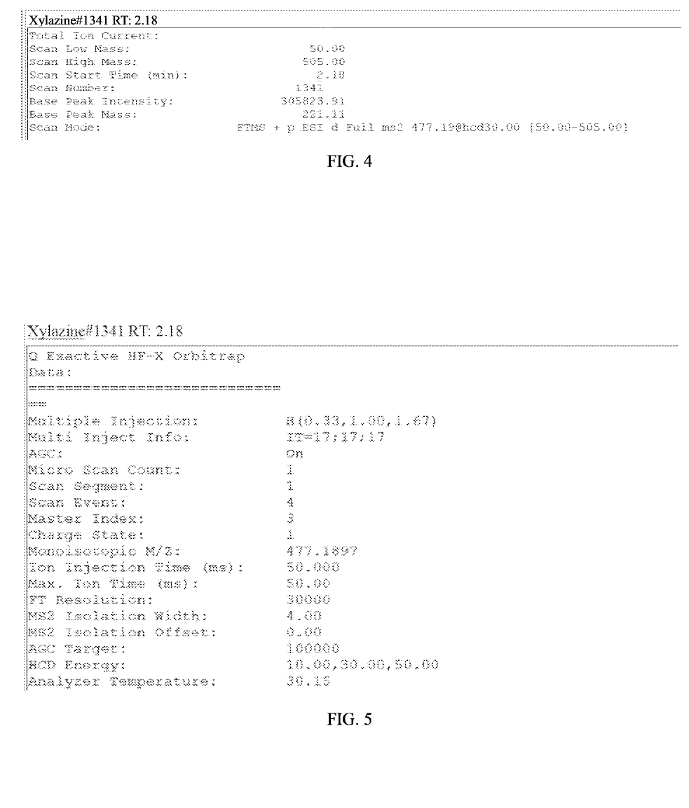

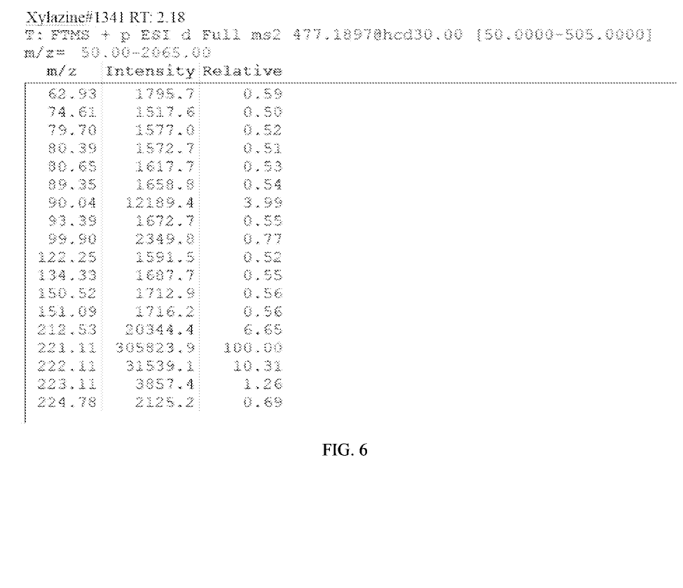

In some embodiments, offset address tables are read from RAW file headers by a processor, where the offset address tables include acquisition parameters, and starting addresses and data lengths of data blocks such as scan directories and indices. The information related to mass spectrometry data (key information) is obtained by serialized parsing of specific data blocks, including spectrum type, spectrum data, Filter (a filter used to define spectrum acquisition scan mode, scan range, ion mode parameters, target ions, and scan mode), and instrument status information. The basic spectrum information is shown in FIG. 4, the instrument status information is shown in FIG. 5, and the spectrum data is shown in FIG. 6. The fingerprint information corresponding to specific data blocks can be generated based on block-based data storage.

The key fragments are bit segments in RAW that are difficult to modify legitimately and are critical for provenance, including file header, acquisition parameters, scan directory and/or index, and binary data block offset and length metadata. For example, the key fragments may include at least one of a file header fixed field, an acquisition parameter field, a scan directory and/or index table, and binary data block offset and length metadata.

The approach is not limited to a single hash of an entire file, but instead provides fine-grained and localizable fingerprinting of vendor key domains, enabling traceability of modification locations.

The rule sets/Schema (schema/model definition) adapts to structural differences and version drift among vendors, and supports incremental and streaming scenarios.

S2: Segmented hash calculation is performed on the key fragments to obtain a structured fingerprint.

The segmented hash refers to a hash value calculated for a single key fragment and metadata thereof.

The structured fingerprint refers to a fingerprint obtained by structurally organizing segmented hash values, such as a Merkle tree and a root thereof (MerkleRoot).

In some embodiments, the structured fingerprint may adopt a Merkle tree structure, where leaf nodes correspond to hash values of RAW key fragments.

In some embodiments, structured fingerprint computation supports parallel processing and incremental processing.

In some embodiments, a processor may, when reading the vendor raw data in chromatography-mass spectrometry, locate bit-level content of key fields and calculate a hash value through segmented hash calculation, thereby obtaining the structured fingerprint.

In some embodiments, a processor may extract key feature bit segments from RAW files in vendor and generate a unique RAW-hash (RAW file hash) fingerprint value. Different vendor RAW formats include specific metadata and index information, such as instrument serial number, method settings, spectral index tables, and data segment checksum values. These pieces of information are critical for describing data source and integrity.

In some embodiments, a processor may define a set of "feature bit" extraction rules for different vendor formats: when reading RAW files, locating bit-level content of these key fields and calculating hash values (for example, using SHA-256, i.e., Secure Hash Algorithm (256-bit)) to generate a fingerprint of the RAW file.

Since fine-grained vendor-specific domain data rather than an entire file is extracted, the fingerprint is capable of capturing core characteristics of the original data and avoiding influence of irrelevant differences. Meanwhile, compared with a simple whole-file MD5 (Message Digest Algorithm 5), the RAW-hash covers more meaningful evidence. Even if the RAW file undergoes lossless compression and repackaging, as long as the key domains are not modified, the RAW-hash remains unchanged; conversely, even if only one spectral data point or metadata entry is modified, the RAW-hash will also change, thereby providing a more sensitive tamper detection capability.

S3: The structured fingerprint is digitally signed to obtain a trusted timestamp and an evidence block is constructed.

A digital signature is a signature of the RAW-hash and related metadata using a digital certificate (for example, using a private key of conversion software or a key of an authorized organization). The digital signature ensures that the fingerprint value cannot be forged or replaced, and once tampered with, signature verification cannot be passed, thereby providing non-repudiation.

The trusted timestamp is a timestamp generated by a trusted time source, which marks the time when RAW data extraction and conversion occur, and the timestamp is also included in a signature scope to prevent post hoc modification. The timestamp chain can further record a time sequence of multi-level processes.

In some embodiments, a processor may obtain a trusted timestamp through a timestamp authority (trusted timestamping authority (TSA)) or an equivalent verifiable time service.

The evidence block is a collection including a structured fingerprint, a digital signature, a certificate chain, and a trusted timestamp token. For example, the evidence block may include: a structured fingerprint, a signature value, a signature algorithm identifier, a signature certificate chain, certificate status information, and a trusted timestamp token.

The evidence block is used for automatic verification during database entry access control and cross-institution data exchange, so as to block untrusted data from entering a data warehouse or sharing platform.

S4: The evidence block and corresponding mapping information are embedded during conversion of the vendor raw data in chromatography-mass spectrometry into a target format data file to obtain an embedding result.

The mapping information refers to a correspondence relationship between RAW fragments and entities or scan identifiers in a target format (such as mzML, a mass spectrometry general data format based on markup language), namely, a correspondence relationship between RAW fragments and scan or spectrum identifiers in the target format file.

The target format is mzML, and the evidence block is provided in an extended field and/or in an attached JSON-LD sidecar.

JSON Linked Data is a JSON-based format used to embed machine-readable data in web pages, sidecar files.

The embedding result is a result obtained in a process of embedding the evidence block and corresponding mapping information during conversion of vendor raw data in chromatography-mass spectrometry into a target format data file.

In some embodiments, a processor may, during conversion of vendor raw data in chromatography-mass spectrometry into a target format data file, embed the evidence block and corresponding mapping information, and record the structured fingerprint, the digital signature, and the trusted timestamp by adding custom fields, thereby obtaining the embedding result.

In some embodiments, a processor may embed fingerprint and signature information into a conversion result when completing conversion from RAW to an open format (such as mzML). Specifically, custom fields may be added in the mzML file or in associated metadata thereof to record the structured fingerprint, the digital signature, and the trusted timestamp, thereby obtaining the embedding result. Such information may be stored in a <run> (markup language run tag) or a <file Description> (markup language file Description tag) of the mzML file, or may be provided as a PROV-O file accompanying mzML release, where PROV data model is expressed using OWL2 Web Ontology Language (OWL2). The key aspect is that the converted open format result carries a "trusted fingerprint" and verification information of the original RAW in a one-to-one correspondence manner, such that the mzML file itself contains a source identity proof. Such embedded fingerprinting implements the "nested doll" principle in TRIZ, where a trusted identifier of original data is embedded within converted data, enabling layered encapsulation of provenance information in data products.

A trustworthy one-to-one correspondence between RAW and mzML is enabled through hash, signature, timestamp, and PROV-O carrying and mapping, thereby achieving an end-to-end closed-loop verification.

S5: The vendor raw data in chromatography-mass spectrometry, conversion activities, responsible entities, and the evidence block are associated based on the embedding result to obtain a provenance record.

The conversion activity refers to conversion of vendor raw data in chromatography-mass spectrometry into a target format data file.

The responsible entity refers to a software tool used for data conversion, a software operator, and corresponding digital signature information thereof.

The provenance record refers to a description of relationships among entities (RAW/target file), activities (conversion/verification), and agents (tool/operator) compliant with PROV-O, and may be represented using JSON-LD or Turtle (TTL format file).

In some embodiments, a processor may construct entities by using the embedding result, and associate the vendor raw data in chromatography-mass spectrometry, conversion activities, responsible entities, and the evidence block through an entity-activity-agent model, thereby obtaining the provenance record.

The entity-activity-agent model is a model that transforms chromatography-mass spectrometry data from "passive storage" into traceable units of "active association". The entity refers to an "object" that can be identified and has explicit attributes, serving as a data or physical carrier of provenance; and an activity refers to a process of performing an operation or transformation on an entity, serving as a process carrier fingerprint of provenance; and a responsible entity for initiating or executing an "activity", serving as a responsibility carrier of provenance.

In some embodiments, a processor may construct a provenance chain based on the W3C PROV-O standard while extracting fingerprints, and describe a lifecycle of mass spectrometry data from acquisition to conversion using PROV-O. Specifically, a processor may create a PROV entity representing a vendor raw data file, where attributes thereof (such as file name and instrument information), a generated RAW-hash fingerprint value, and an extraction timestamp are recorded; and define a conversion activity entity (Activity) representing a process of converting RAW into mzML using a specific conversion tool (for example, a tool named Proteo Wizard msConvert). In a PROV chain, the RAW entity is used as input and used by the conversion activity, and an mzML entity is generated as output. The instruments, conversion software, and operators involved are associated as Agents through the PROV entity-activity-agent model. The mzML entity records a corresponding RAW-hash fingerprint, a replica signature, and a conversion timestamp.

PROV-O (Provenance Ontology) is a W3C-recommended ontology model used for representing data generation and conversion processes, and is used for exchanging and representing data provenance information among different systems (w3.org).

Through the above manner, a machine-readable PROV provenance record can be formed, clearly describing original data source, conversion steps, temporal order, and participants. The provenance chain adopts a timestamp chain manner to ensure that the sequence is tamper-resistant: each PROV record node is attached with an event time, and a hash chain may optionally be used to link preceding and succeeding steps (for example, a previous RAW-hash is included in a signature of a conversion output to form a chain dependency). Such a chain structure is similar to a blockchain concept, ensuring that modification of any step record will break consistency of subsequent chain elements. By using a standard PROV-O format, the interoperability and long-term usability of provenance information across different vendors and software environments are ensured.

S6: The vendor raw data in chromatography-mass spectrometry is recalculated by using the evidence block based on the provenance record, and the structured fingerprint, the digital signature, and the trusted timestamp are compared, thereby obtaining a trusted fingerprint provenance result, and completing traceable and reliable fingerprinting of vendor raw data in chromatography-mass spectrometry.

The trusted fingerprint provenance result reflects a trustworthiness of vendor raw data in chromatography-mass spectrometry, namely a result of detection rate for falsification or tampering.

In some embodiments, a processor may recalculate vendor raw data in chromatography-mass spectrometry by using an evidence block based on a provenance record to obtain key hash values; compare the structured fingerprint, the digital signature, and the trusted timestamp respectively by using the key hash values, verify whether the digital signature is valid, check whether a timestamp chain sequence is reasonable, and trigger an anomaly alert when any verification step is mismatched, thereby obtaining the trusted fingerprint provenance result, and completing traceable and reliable fingerprinting of the vendor raw data in chromatography-mass spectrometry.

The key hash value is a hash value recalculated for vendor raw data in chromatography-mass spectrometry by using an evidence block.

In some embodiments, when mzML data and a provenance record thereof are obtained, a processor may use a dedicated verification tool or script to verify a PROV chain step by step: first, a key hash value of a provided RAW file (or a RAW file obtained from data storage) is calculated to determine whether the key hash value is consistent with a RAW-hash recorded in mzML; then, validity of a digital signature is verified by using a trusted public key to confirm integrity of the signature and to confirm that the structured fingerprint in mzML is generated during an original conversion; next, a timestamp chain sequence is checked to determine whether a time reversal or an abnormal temporal condition exists. The raw file size and spectrum number described in a PROV record may further be compared with actual mzML content to determine consistency. When any verification step is mismatched, an anomaly alert is triggered. For example, a mismatch of RAW-hash indicates that the provided RAW file is not an original source file or has been modified; signature verification failure indicates that data may have been tampered with or a signature is invalid; a timestamp outside an expected range may indicate abnormal post hoc modification, thereby obtaining a trusted fingerprint provenance result.

The alert may be notified to a data receiver or a data warehouse administrator through a log, an email, or an interface warning, and a detection rate for falsification or tampering is close to 100%. Such a mechanism ensures that any attempt to replace original data, modify mzML content, or forge time information leaves traces and is detectable.

In some embodiments, when data is further processed (such as database searching or quantitative analysis), a fingerprint of a previous result is incorporated into a new PROV record at each step, and a longer chain is formed. For example, when mzML is further used to generate a processing report PDF, a hash signature of a source mzML may be attached in PDF metadata, thereby forming an extended chain and a trusted data chain from end to end. A user is enabled to trace back to an original RAW source at any stage, thereby improving data trustworthiness.

A signing private key is hosted in a hardware security module (HSM), and certificate revocation and auditing are supported.

The anomaly alerts include localization information of a tampered fragment and a provenance pointer of a corresponding processing activity.

In some embodiments, after data acquisition is completed, a system selects file headers, acquisition parameter blocks, scan directory indices, and data block offset tables as key fragments according to a Thermo Vendor RuleSet; SHA-256 hash values are calculated segment by segment, a Merkle tree is constructed, and a root value is obtained. An elliptic curve digital signature algorithm (ECDSA) private key is used to sign the Merkle root, and a trusted timestamp is obtained through a TSA to generate an evidence block. During conversion from RAW to mzML, the evidence block and mapping information are embedded into mzML extension fields or provided in an attached sidecar JSON-LD, and a Prov Bundle (association of RAW, conversion activities, tools/operators, and timestamps) is output simultaneously. During verification, a key fragment hash of RAW is recalculated and compared with a Merkle root, a signature, a timestamp, and a certificate status; when inconsistency occurs, an anomaly is triggered, and abnormal fragments and corresponding processing activities are localized according to mapping information.

A sidecar file is an external JSON/JSON-LD file accompanying a target format file, and is used to carry an evidence block and provenance information.

In some embodiments, a processor may define key fragments for an index file, a metadata file, and binary blocks in a directory structure respectively, and calculate segmented hash values; construct a structured fingerprint and an evidence block; and record mapping information indicating a correspondence between RAW fragments and mzML scan identifiers. The sidecar-based approach carries the evidence block and the provenance record, avoids modification of the RAW body, and ensures that the original file is not contaminated.

Through the above manner, parallel, block-based, and streaming fingerprint computation is supported; a signing private key is hosted in HSM, with certificate revocation checking and auditing supported; optional chained timestamps or append-only logs are used to enhance non-repudiation; the approach is used as an automatic verification precondition for SRD database entry access control and cross-institution data exchange; and evidence is externalized or embedded into target format extension fields, thereby ensuring independence of original evidence.

In some embodiments, the method for traceable and reliable fingerprinting of vendor raw data in chromatography-mass spectrometry has wide vendor format adaptability. Through a modular fingerprint extraction strategy, Raw Trust may support RAW data formats of major mass spectrometry instruments including Thermo, Agilent, Bruker, Waters, SCIEX, and Shimadzu, covering data types of vendors in the United States, Europe, Japan, and China. The key fields of each format are different, but stable and difficult-to-forge byte segments may be selected according to publicly available or reverse-engineered file structures to calculate RAW-hash. For example, for Thermo RAW, a File Header (file header of the RAW file) and spectrum indices may be extracted; for Agilent .d folders, spectral data file hashes and method parameters may be extracted; and for Bruker .baf files, checksum information of data block directories may be extracted. Such a targeted approach ensures that fingerprint computation is both based on a unified principle and adapted to specific conditions.

In some embodiments, a processor may perform testing and verification on multiple sets of real sample data by using a developed prototype tool. During a normal conversion process, a fingerprint carried in mzML is consistent with a fingerprint calculated from an original RAW file, and signature verification passes. In a simulated tampering scenario (such as modifying peaks in mzML or replacing part of RAW data), a verification tool is capable of successfully detecting inconsistency and generating an alert. The prototype verification data covers RAW samples from Thermo instruments and domestic instruments, demonstrating feasibility and effectiveness of the method.

The validation may be performed in real time at any stage of data production, transmission, database entry, or data sharing, thereby significantly improving detection rate for falsification or tampering and traceability.

In some embodiments of this specification, a method for traceable and reliable fingerprinting of vendor raw data in chromatography-mass spectrometry is provided, where key fragments, including key header fields and indices of RAW, are selected based on a vendor rule set, segmented hash values are calculated and organized as a structured fingerprint, and the structured fingerprint is digitally signed and timestamped; during conversion of RAW into a target format, the evidence block, mapping information from RAW to the target format, and the provenance record are embedded together or attached together; and during a verification stage, the structured fingerprint, the signature, and the timestamp are recalculated and compared, and an anomaly is alerted and a fragment is localized when an abnormality occurs. Through this method, the fine-grained and localizable integrity verification of key domains of the vendor can be achieved; the continuous-chain provenance can be achieved during conversion from RAW to the target format; the adaptation of rule sets across vendors and versions is supported; and therefore the method is suitable for database access control, cross-institution exchange, and real-time verification. Under conditions that key domains are reasonably selected and signature/timestamp implementation is correct, a high detection rate for unauthorized modification can be achieved and false positives can be significantly reduced.

### Embodiment 3

In some embodiments, a device for traceable and reliable fingerprinting of vendor raw data in chromatography-mass spectrometry includes a processor, where the processor is configured to execute the method for traceable and reliable fingerprinting of vendor raw data in chromatography-mass spectrometry.

In some embodiments, the selector module may be implemented by software, and is configured to extract key data blocks of raw chromatography-mass spectrometry data files of different vendors and different data formats according to a rule set definition, where the key data blocks include a file header, a chromatographic data region, a mass spectrometry data region, and a scan information region, and the key data blocks are used as key fragment data (feature data) of the chromatography-mass spectrometry data file and are used as input data for a subsequent fingerprint generation module.

In some embodiments, the fingerprint generation module may be implemented by software, and is configured to calculate hash values of the key fragment (feature) data generated by the selector module.

In some embodiments, the signature and timestamp module may be executed by a smart cryptographic key device, including a USBKey device inserted into a USB port of a server, and a cryptographic machine (an independent server including a CA certificate of a signing authority or personnel and non-exportable private key of the certificate, and data is signed by the private key, thereby ensuring reliability of signer identity, tamper resistance of signed data, and verifiability).

The timestamp is generated by a timestamp server (an independent server compliant with RFC3161, including a timestamp digital certificate and connected to a trusted precise time source, thereby ensuring reliability of signing time, tamper resistance of timestamped data, and verifiability). The signature and timestamp module is configured to perform CA digital certificate signing and RFC3161 timestamp notarization on hash values of key fragment (feature) data, thereby obtaining CA signature data and timestamp data of fingerprint data.

In some embodiments, the binding and output module may be implemented by software, and is configured to convert a raw chromatography-mass spectrometry data file into a public format (such as mzML) and output the result, and embed corresponding fingerprint data (hash values), CA signature data, and timestamp data into the output file or provide the same as an attachment file.

In some embodiments, the provenance record module may be implemented by software, and is configured to generate an operation provenance record corresponding to processing flows of the selector module, the fingerprint generation module, the signature and timestamp module, and the binding and output module, for reproduction verification and data validation.

In some embodiments, the verification and alert module may be implemented by software, and is configured to, based on the provenance record, an original chromatography-mass spectrometry data file, and an output public format file (including fingerprint data, CA signature data, and timestamp data), perform recalculation-based verification of the original chromatography-mass spectrometry data file (such as fingerprint recalculation), and verify CA signature and timestamp, thereby generating a verification result of data consistency before and after conversion or an anomaly alert.

### Embodiment 4

In some embodiments, provided is a computer-readable storage medium, where the storage medium stores computer instructions, and when a computer reads the computer instructions stored in the storage medium, the computer may execute the method for traceable and reliable fingerprinting of vendor raw data in chromatography-mass spectrometry.

### Embodiment 5

In the field of metrology, when authoritative reference data sets, paper data, and experimental data are submitted, the submitted data are mainly in mzML format, and corresponding original data are mostly derived from vendor-acquired raw chromatography-mass spectrometry data acquired by commercial instruments. All subsequent data analysis results are derived based on mzML data files. Therefore, the authenticity, accuracy, data traceability, and anti-counterfeiting verification of mzML are particularly important. Current data verification methods mainly perform numerical comparison between original data and converted result data, and implement data provenance by associating original file names and whole-file hash values. However, such methods are unable to trace and verify a data conversion process, including specific time of data conversion generation and a conversion entity.

In some embodiments, provided is a method for traceable and reliable fingerprinting of vendor raw data in chromatography-mass spectrometry, which includes:

S1: selecting vendor raw data in chromatography-mass spectrometry of reference data for emerging organophosphorus contaminants based on a vendor rule set to obtain key fragments;

S2: performing segmented hash calculation on the key fragments to obtain a structured fingerprint;

S3: digitally signing the structured fingerprint to obtain a trusted timestamp and constructing an evidence block;

S4: embedding the evidence block and corresponding mapping information during conversion of the vendor raw data in chromatography-mass spectrometry into a target format data file to obtain an embedding result;

S5: associating the vendor raw data in chromatography-mass spectrometry, conversion activities, responsible entities, and the evidence block based on the embedding result to obtain a provenance record; and

S6: recalculating vendor raw data in chromatography-mass spectrometry based on the provenance record by using the evidence block, comparing the structured fingerprint, the digital signature, and the trusted timestamp, and obtaining a trusted fingerprint provenance result of reference data for emerging organophosphorus contaminants, thereby completing traceable and reliable fingerprinting of vendor raw data in chromatography-mass spectrometry of reference data for emerging organophosphorus contaminants.

In some embodiments, the S2 includes:

when reading the vendor raw data in chromatography-mass spectrometry of reference data for emerging organophosphorus contaminants, locating bit-level content of key fields, and calculating a hash value through segmented hash calculation to obtain a structured fingerprint.

In some embodiments, the S4 includes:

during conversion of vendor raw data in chromatography-mass spectrometry of reference data for emerging organophosphorus contaminants into a target format data file, embedding an evidence block and corresponding mapping information, and recording the structured fingerprint, the digital signature, and the trusted timestamp by adding custom fields, thereby obtaining an embedding result.

In some embodiments, the S5 includes:

constructing entities by using the embedding result, and associating the vendor raw data in chromatography-mass spectrometry, conversion activities, responsible entities, and the evidence block through an entity-activity-agent model, thereby obtaining the provenance record.

In some embodiments, the S6 includes:

recalculating the vendor raw data in chromatography-mass spectrometry by using the evidence block based on the provenance record to obtain key hash values;

comparing the structured fingerprint, the digital signature, and the trusted timestamp respectively by using the key hash values, verifying whether the digital signature is valid, checking whether a timestamp chain sequence is reasonable, and triggering an anomaly alert when any verification step is mismatched, thereby obtaining the trusted fingerprint provenance result of reference data for emerging organophosphorus contaminants, and completing traceable and reliable fingerprinting of the vendor raw data in chromatography-mass spectrometry of reference data for emerging organophosphorus contaminants.

Through the above manner, the trustworthiness and authority of reference data for emerging organophosphorus contaminants are improved, and a technical system support is provided for international and inter-institution metrology data mutual recognition.

It should be noted that different embodiments may produce different beneficial effects. In different embodiments, the beneficial effects may be any one or a combination of the above, or any other possible beneficial effects.

What is claimed is:

1. A method for traceable and reliable fingerprinting of vendor raw data in chromatography-mass spectrometry, comprising:
S1: selecting vendor raw data in chromatography-mass spectrometry based on a vendor rule set to obtain key fragments;
S2: performing segmented hash calculation on the key fragments to obtain a structured fingerprint;
S3: digitally signing the structured fingerprint to obtain a trusted timestamp and constructing an evidence block;
S4: embedding the evidence block and corresponding mapping information during conversion of the vendor raw data in chromatography-mass spectrometry into a target format data file to obtain an embedding result;
S5: associating the vendor raw data in chromatography-mass spectrometry, conversion activities, responsible entities, and the evidence block based on the embedding result to obtain a provenance record; and
S6: recalculating the vendor raw data in chromatography-mass spectrometry using the evidence block based on the provenance record, and comparing the structured fingerprint, digital signature, and the trusted timestamp to obtain a trusted fingerprint provenance result, thereby completing traceable and reliable fingerprinting of vendor raw data in chromatography-mass spectrometry.

2. The method for traceable and reliable fingerprinting of vendor raw data in chromatography-mass spectrometry according to claim 1, wherein the S2 comprises:
locating bit-level content of key fields when reading the vendor raw data in chromatography-mass spectrometry, and calculating a hash value through segmented hash calculation, thereby obtaining a structured fingerprint.

3. The method for traceable and reliable fingerprinting of vendor raw data in chromatography-mass spectrometry according to claim 1, wherein the S4 comprises:
embedding the evidence block and corresponding mapping information during conversion of the vendor raw data in chromatography-mass spectrometry into the target format data file, recording the structured fingerprint, digital signature, and the trusted timestamp by adding custom fields, thereby obtaining the embedding result.

4. The method for traceable and reliable fingerprinting of vendor raw data in chromatography-mass spectrometry according to claim 1, wherein the S5 comprises:
constructing entities by using the embedding result, and associating the vendor raw data in chromatography-mass spectrometry, conversion activities, responsible entities, and the evidence block through an entity-activity-agent model, thereby obtaining the provenance record.

5. The method for traceable and reliable fingerprinting of vendor raw data in chromatography-mass spectrometry according to claim 1, wherein the S6 comprises:
recalculating the vendor raw data in chromatography-mass spectrometry by using the evidence block based on the provenance record to obtain key hash values;
comparing the structured fingerprint, the digital signature, and the trusted timestamp respectively by using the key hash values, verifying whether the digital signature is valid, checking whether a timestamp chain sequence is reasonable, and triggering an anomaly alert when any verification step is mismatched, thereby obtaining the trusted fingerprint provenance result, and completing traceable and reliable fingerprinting of the vendor raw data in chromatography-mass spectrometry.

6. A system for traceable and reliable fingerprinting of vendor raw data in chromatography-mass spectrometry, configured to execute the method for traceable and reliable fingerprinting of vendor raw data in chromatography-mass spectrometry according to claim 1, comprising:
a selector module, configured to select vendor raw data in chromatography-mass spectrometry based on a vendor rule set to obtain key fragments;
a fingerprint generation module, configured to perform segmented hash calculation on the key fragments to obtain a structured fingerprint;
a signature and timestamp module, configured to digitally sign the structured fingerprint to obtain a trusted timestamp and construct an evidence block;
a binding and output module, configured to embed the evidence block and corresponding mapping information during conversion of the vendor raw data in chromatography-mass spectrometry into a target format data file to obtain an embedding result;
a provenance record module, configured to associate the vendor raw data in chromatography-mass spectrometry, conversion activities, responsible entities, and the evidence block based on the embedding result to obtain a provenance record; and
a verification and alert module, configured to recalculate the vendor raw data in chromatography-mass spectrometry using the evidence block based on the provenance record, compare the structured fingerprint, digital signature, and the trusted timestamp to obtain a trusted fingerprint provenance result, thereby completing traceable and reliable fingerprinting of vendor raw data in chromatography-mass spectrometry.

7. A device for traceable and reliable fingerprinting of vendor raw data in chromatography-mass spectrometry, comprising a processor, wherein the processor is configured to execute the method for traceable and reliable fingerprinting of vendor raw data in chromatography-mass spectrometry according to claim 1.

8. A computer-readable storage medium, wherein the computer-readable storage medium stores computer instructions, and when a computer reads the computer instructions stored in the storage medium, the computer executes the method for traceable and reliable fingerprinting of vendor raw data in chromatography-mass spectrometry according to claim 1.
